(19) United States
(12) Patent Application Publication
(10) Pub. No.: US 2024/0346571 A1
(43) Pub. Date: Oct. 17, 2024

(54) SYSTEMS AND METHODS FOR OPTIMIZING AVAILABILITY OF PRODUCTS ON A WEBPAGE OR GRAPHICAL USER INTERFACE

(71) Applicant: Coupang Corp., Seoul (KR)

(72) Inventors: Issac KWON, Gyeonggi-do (KR); Deepak MAHESHWARI, Seoul (KR); Sunghee KIM, Seoul (KR); Naveen Kumar GOVINDARAJU, Seoul (KR); Yuyeon OH, Gwangmyeong-si (KR)

(73) Assignee: Coupang Corp., Seoul (KR)

(21) Appl. No.: 18/508,064

(22) Filed: Nov. 13, 2023

Related U.S. Application Data
(63) Continuation-in-part of application No. 18/507,785, filed on Nov. 13, 2023.
Application No. 18/507,785 is a continuation-in-part of application No. 18/299,854, filed on Apr. 13, 2023.

(51) Int. Cl. G06Q 30/0601; G06Q 10/0875

(52) U.S. Cl. CPC G06Q 30/0641; G06Q 10/0875

(57) ABSTRACT

The present disclosure provides systems and methods for optimizing availability of products for display on a GUI. Disclosed embodiments involve receiving scan events associated with products and determining ranges of time based at least on historic data. For each scan event, determining whether the scan event is received within a first range of time, determining whether the current location corresponds to a first location, and when the scan event is received within the first range of time and the current location corresponds to the first location, updating the database to indicate products available for sale at a first time. When the scan event is received after the first range of time and the current location does not correspond to the first location, determining whether to update the database at a second time. Embodiments further involve generating a GUI and transmitting the GUI to at least one customer device.

### PRIORITY CLAIM

This application is a continuation-in-part of U.S. Nonprovisional patent application Ser. No. 18/507,785, filed on Nov. 13, 2023, which is a continuation-in-part of U.S. Nonprovisional patent application Ser. No. 18/299,854, filed on Apr. 13, 2023, the contents of each of which is herein incorporated by reference in their entireties.

### TECHNICAL FIELD

The present disclosure generally relates to computerized systems and methods for optimizing the availability of products on a webpage or a graphical user interface. In particular, embodiments of the present disclosure relate to inventive and unconventional systems related to the rapid reconciliation of in-transit, inbound and stowed products and the modification of webpages using computing systems based on the quantity of products in transit, received and stowed, and based on the time that products are received.

### BACKGROUND

In traditional systems and methods for indicating a quantity of products that are available to sell to a customer, the quantity of products marked as available (e.g., available to sell or in stock) may be limited to products that have been received and stowed at a fulfillment center. The locations of stowed products may be stored in, for example, a database for locating, picking, and shipping the products to customers. However, products received at a fulfillment center, but not yet stowed, may not be considered available to sell (e.g., may be marked as or considered unavailable or out of stock). Furthermore, the database may not include locations of received, but not yet stowed, products. Products that are not yet stowed, but received at the fulfillment center, being considered unavailable may result in a large discrepancy between the number of products received at a fulfillment center and the number of products that are sold to customers, resulting in a decrease in gross profit margins.

While it may be possible to build new fulfillment systems to account for received but not yet stowed products, such an undertaking is technologically difficult and time consuming. Existing systems simply are not built to account for unstowed items in inventory and significant code changes to those systems can break existing functionality.

Therefore, there is a need for improved systems and methods for optimizing the availability of products on a webpage or graphical user interface without breaking existing data infrastructure, where the availability may indicate that the products are available to sell to a customer and/or available for a customer to purchase. In particular, there is a need for improved systems and methods for marking, indicating, or otherwise considering not yet stowed products as available and providing locations of not yet stowed products to fulfillment center personnel for expedited stowing.

### SUMMARY

One aspect of the present disclosure is directed to a computer-implemented system comprising a memory storing instructions and at least one processor configured to execute the instructions to perform a method for optimizing availability of products for display on a graphical user interface. The method includes receiving a plurality of scan events associated with a plurality of products, wherein each scan event of the plurality of scan events comprises a timestamp and a current location, determining a plurality of ranges of time based at least on historic data stored in a database, wherein each range of time of the plurality of ranges of time is associated with a destination fulfillment center and, for each scan event of the plurality of scan events, determining whether the scan event is received within a first range of time of the plurality of ranges of time, determining whether the current location of the scan event corresponds to a first location, wherein the first location is not the destination fulfillment center, and when the scan event is received within the first range of time and the current location corresponds to the first location, updating the database to indicate that a first subset of products of the plurality of products associated with the scan event is available for sale at a first time. The method further includes, when the scan event is received after the first range of time and the current location does not correspond to the first location, determining, at a second time after the first time, whether to update the database to indicate that the first subset of products is available for sale, generating, at the first time, a graphical user interface, the graphical user interface comprising a product availability for each product of the plurality of products, and transmitting the graphical user interface to at least one customer device.

Another aspect of the present disclosure is directed to a method for optimizing availability of products for display on a graphical user interface. The method includes receiving a plurality of scan events associated with a plurality of products, wherein each scan event of the plurality of scan events comprises a timestamp and a current location, determining a plurality of ranges of time based at least on historic data stored in a database, wherein each range of time of the plurality of ranges of time is associated with a destination fulfillment center and, for each scan event of the plurality of scan events, determining whether the scan event is received within a first range of time of the plurality of ranges of time, determining whether the current location of the scan event corresponds to a first location, wherein the first location is not the destination fulfillment center, and when the scan event is received within the first range of time and the current location corresponds to the first location, updating the database to indicate that a first subset of products of the plurality of products associated with the scan event is available for sale at a first time. The method further includes, when the scan event is received after the first range of time and the current location does not correspond to the first location, determining, at a second time after the first time, whether to update the database to indicate that the first subset of products is available for sale, generating, at the first time, a graphical user interface, the graphical user interface comprising a product availability for each product of the plurality of products, and transmitting the graphical user interface to at least one customer device.

Yet another aspect of the present disclosure is directed to a computer-implemented system comprising a memory storing instructions, and at least one processor configured to execute the instructions to perform a method for optimizing availability of products for display on a graphical user interface. The method includes receiving a plurality of scan events associated with a plurality of products, wherein each scan event of the plurality of scan events comprises a timestamp and a current location, determining a plurality of ranges of time based at least on historic data stored in a database, wherein determining the plurality of ranges of time includes predicting one or more lead times associated with the plurality of products and, for each scan event of the plurality of scan events, determining whether the scan event is received within a first range of time of the plurality of ranges of time, determining whether the current location of the scan event corresponds to a first location, and based on determining that the scan event is received within the first range of time and the current location corresponds to the first location, updating the database to indicate that a first subset of products of the plurality of products associated with the scan event is available for sale at a first time. The method further includes, based on determining that the scan event is received after the first range of time and the current location does not correspond to the first location, determining, at a second time after the first time, whether to update the database to indicate that the first subset of products is available for sale, generating a graphical user interface, the graphical user interface comprising a product availability for each product of the plurality of products, and transmitting the graphical user interface to at least one customer device.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary zone configured to store stowed products, consistent with the disclosed embodiments.

FIG. 4 is a diagrammatic illustration of an exemplary operation of a stowing worker in a zone, consistent with the disclosed embodiments.

FIG. 5 is a schematic block diagram illustrating an exemplary embodiment of a system comprising an available to sell management system, consistent with the disclosed embodiments.

FIG. 6 is a flowchart illustrating an exemplary embodiment of a method for optimizing a quantity of products that are available to sell, according to some disclosed embodiments.

FIG. 7 depicts a sample Stow page that includes products to be stowed and a priority stow indication, consistent with the disclosed embodiments.

FIG. 8 is a flowchart illustrating an exemplary embodiment of a method for optimizing a quantity of products that are available to sell, according to some disclosed embodiments.

FIG. 9 is a flow diagram illustrating an exemplary embodiment for optimizing a quantity of products that are available to sell, according to some disclosed embodiments.

FIG. 10 is a flowchart illustrating an exemplary embodiment of a method for optimizing a quantity of products that are available to sell, according to some disclosed embodiments.

FIG. 11 is a flow diagram illustrating an exemplary embodiment for optimizing a quantity of products that are available to sell, according to some disclosed embodiments.

FIG. 12 depicts a sample graphical user interface (GUI) that includes a product and information about the product along with interactive user interface elements, according to some disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Additionally, some of the described embodiments or elements thereof can occur or be performed (e.g., executed) simultaneously, at the same point in time, or concurrently. Accordingly, the following detailed description is not limited to the disclosed embodiments and examples. Instead, the proper scope of the invention is defined by the appended claims.

Embodiments of the present disclosure are directed to systems and methods configured for optimizing a quantity of products for display on a graphical user interface.

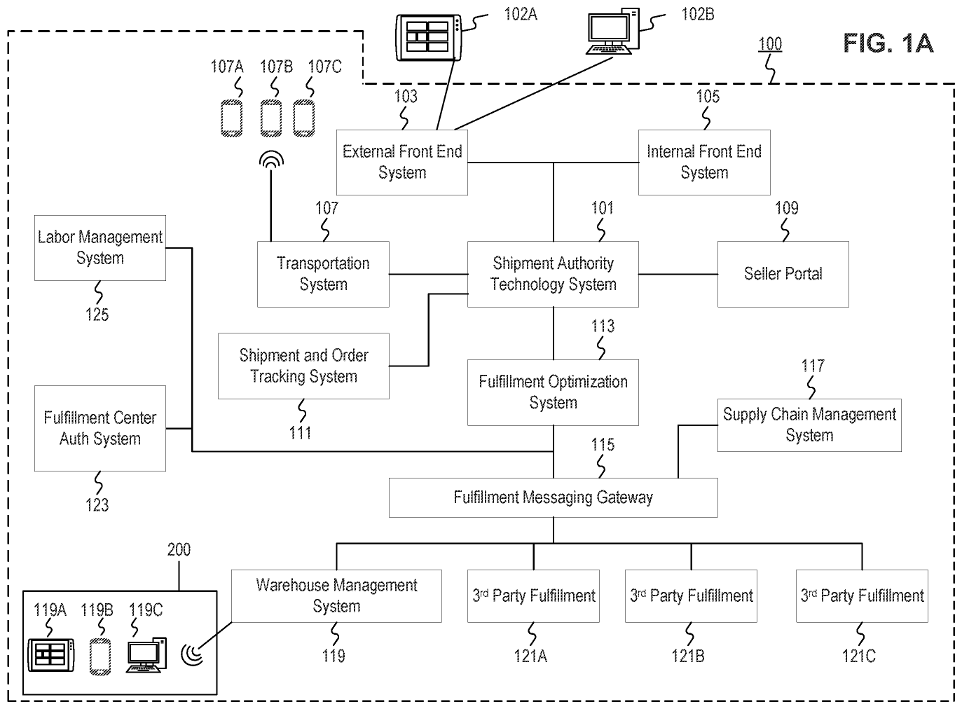

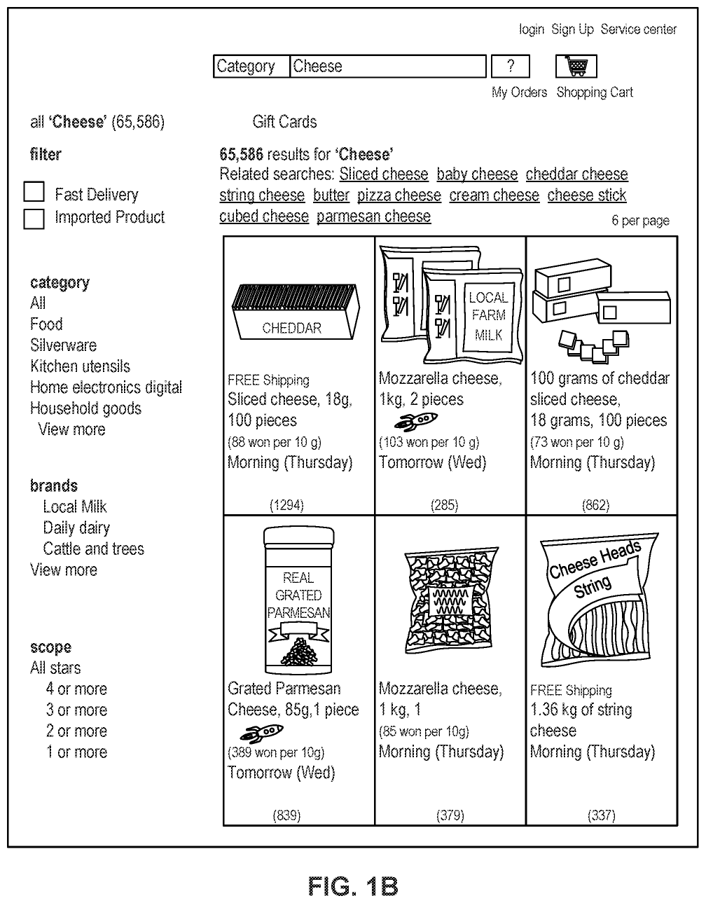

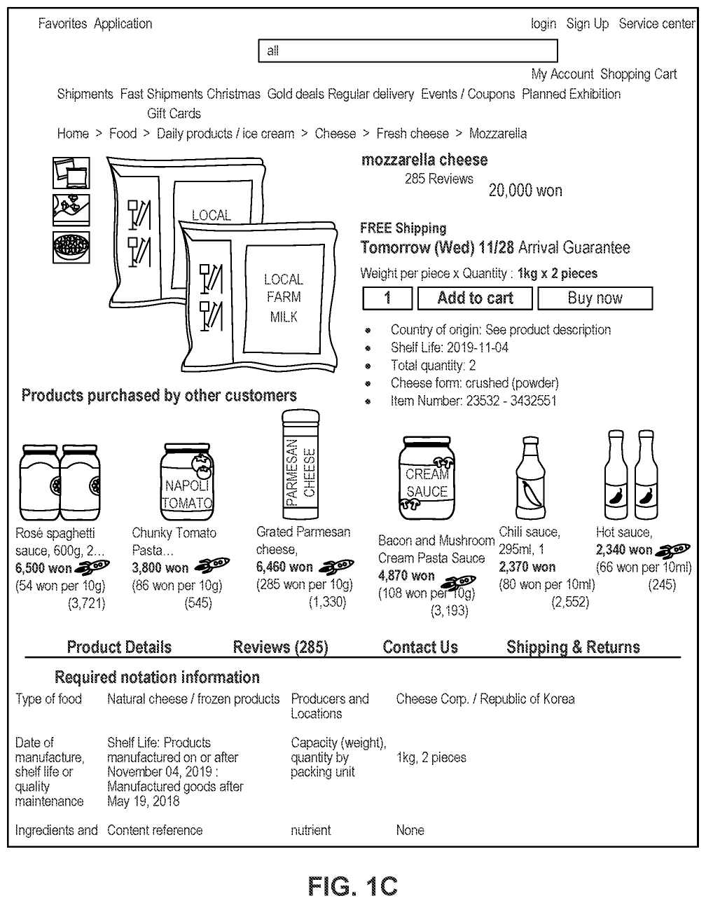

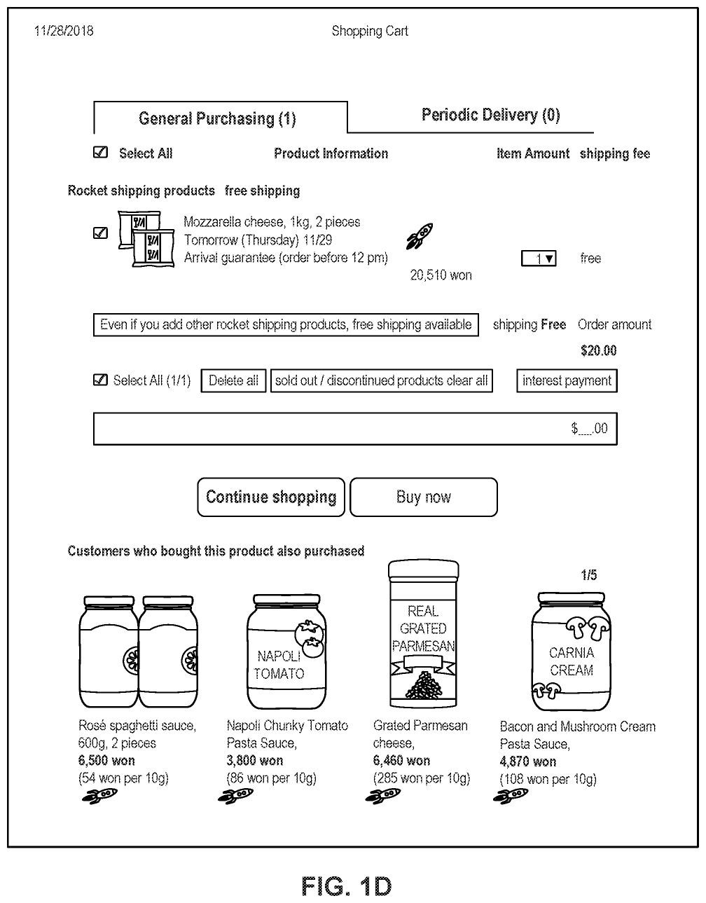

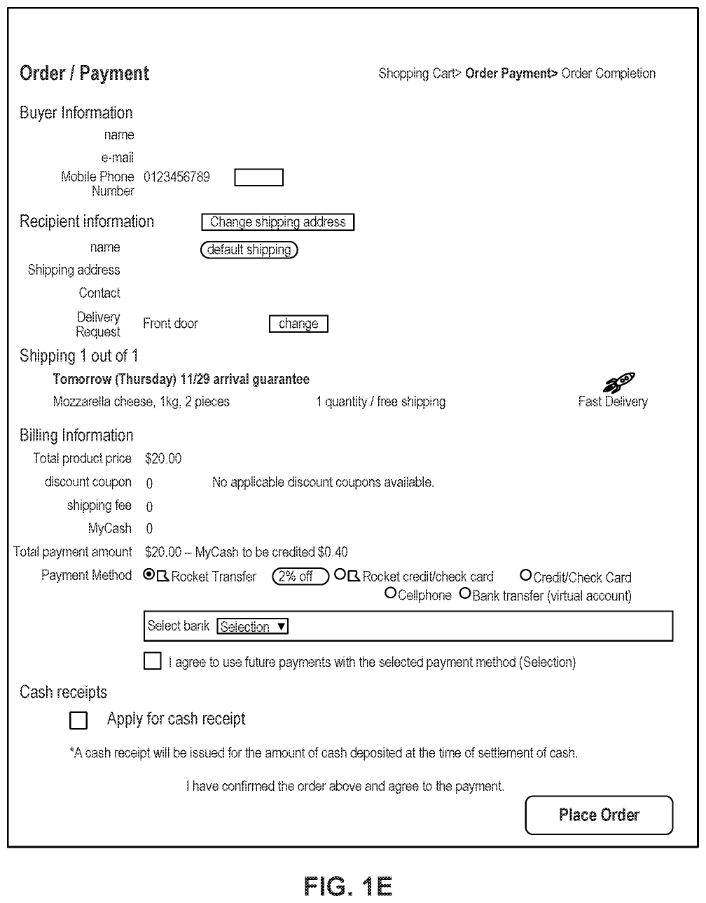

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, an “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in systems 100 or 500, such as FO system 113 or available to sell management system 501, converts it to another format or protocol, and forwards it in the converted format or protocol to other systems, such as WMS 119, 3^{rd} party fulfillment systems 121A, 121B, or 121C, user device 503, and vice versa. For example, FMG 115 may allow user devices 503 to access up-to-date product availability based on product information received from available to sell management system 501 by converting the received product information from a non-standardized format or first protocol to a standardized format or second protocol.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

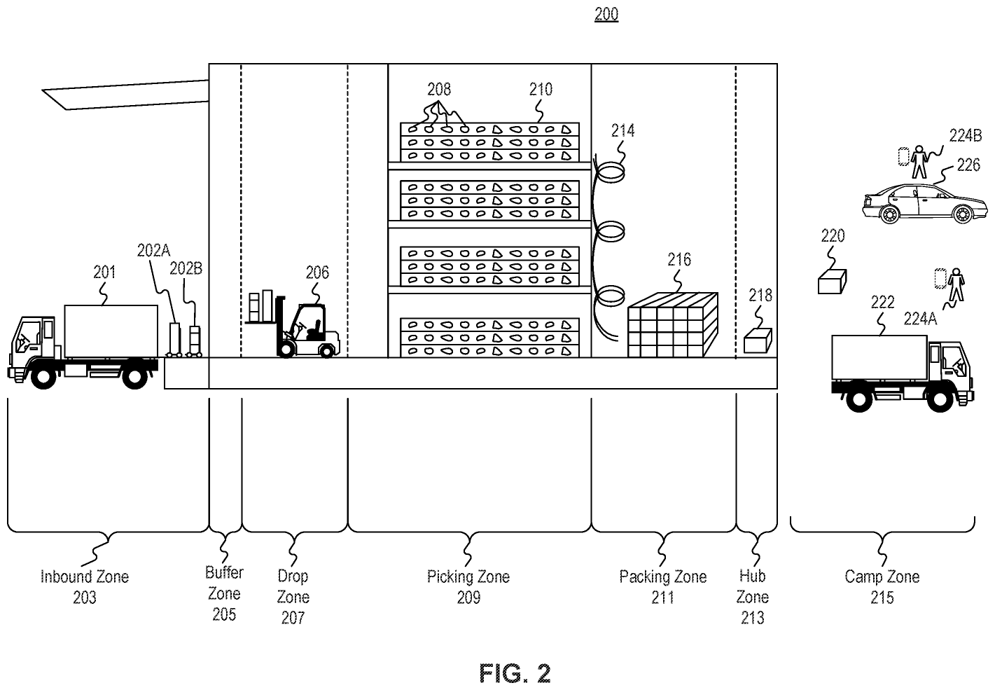

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3rd party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

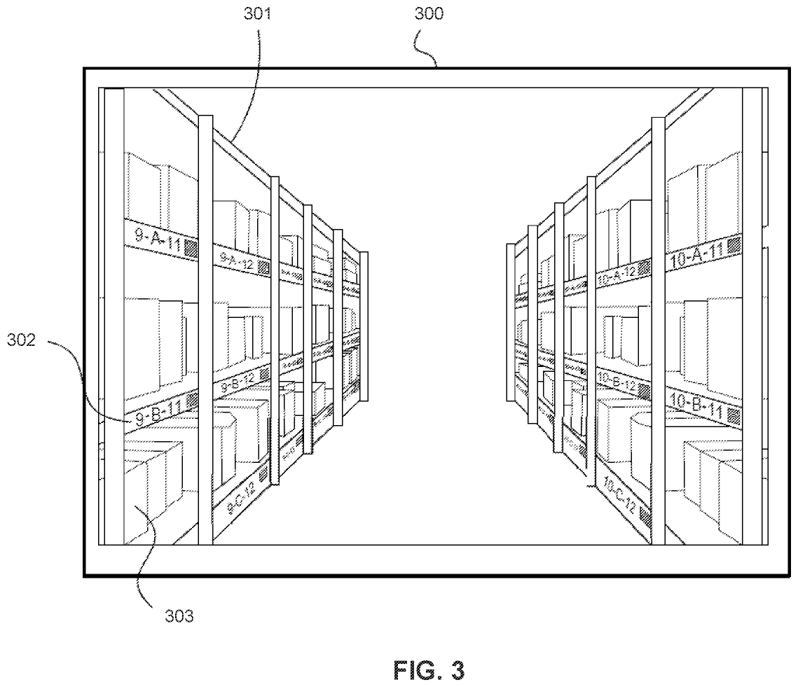

FIG. 3 illustrates a zone 300 configured to store stowed products in accordance with the disclosed embodiments. When inbound products are received in a warehouse, such as FC 200, a user, such as a stowing worker or other fulfillment center personnel, may begin scanning product identifiers associated with the inbound products before stowing the inbound products in one or more zones 300 within FC 200. For example, the user may scan, using a user device (e.g., one of devices 119A-119C), a product identifier associated with an inbound product for stowing, input a quantity of the inbound product for stowing using the user device, and select a zone 300 for stowing the inbound product. The user device may send the scanned product identifier, the quantity of the inbound product, and the selected zone 300 to WMS 119. WMS 119 may display a list of physical location identifiers 303 within the selected zone 300 on the user device. The list of physical location identifiers 303 may be associated with corresponding storage units 301, at which the inbound product may be stowed.

Zone 300 may comprise a picking zone, such as picking zone 209 of FIG. 2, or a buffer zone, such as buffer zone 205 of FIG. 2. As shown in FIG. 3, zone 300 may be in a warehouse, such as FC 200. In zone 300, inbound products 303 may be stowed in storage units 301, which may include physical location identifiers 302. Storage units 301, in some embodiments, may be physical shelving, bookshelves, boxes, totes, refrigerators, freezers, cold stores, or any other structure for storing products. Stowed inbound products 303, in some embodiments, may be available for purchase by a customer and may be picked by a user (such as a stowing worker) or a machine, or when a customer places an order for stowed inbound products 303 via a website hosted by external front end system 103. Physical location identifiers 302, in some embodiments, may be a unique address of a particular location of storage units 301.

In some embodiments, storage units 301, such as shelving, may have physical location identifiers 302 attached to them. Physical location identifiers 302 may be a unique address of a particular location of storage units 301. In some embodiments, physical location identifier 302 may indicate a particular product that is shelved at the location. In other embodiments, physical location identifier 302 may indicate multiple products that are shelved together or placed closely together. Physical location identifier 302 may be a product barcode, RFID tag, or a matrix barcode, such as a Quick Response (QR) code. A camera or a scanner in a user device, such as a mobile device 119B, may scan physical location identifier 302 using an input device, such as an imaging device including a camera or a scanner. The scanned information may be sent to WMS 119. Based on the scanned information, WMS 119 may determine whether a user and/or the user device (e.g., one of devices 119A-119C) is at a location that is designated by WMS 119.

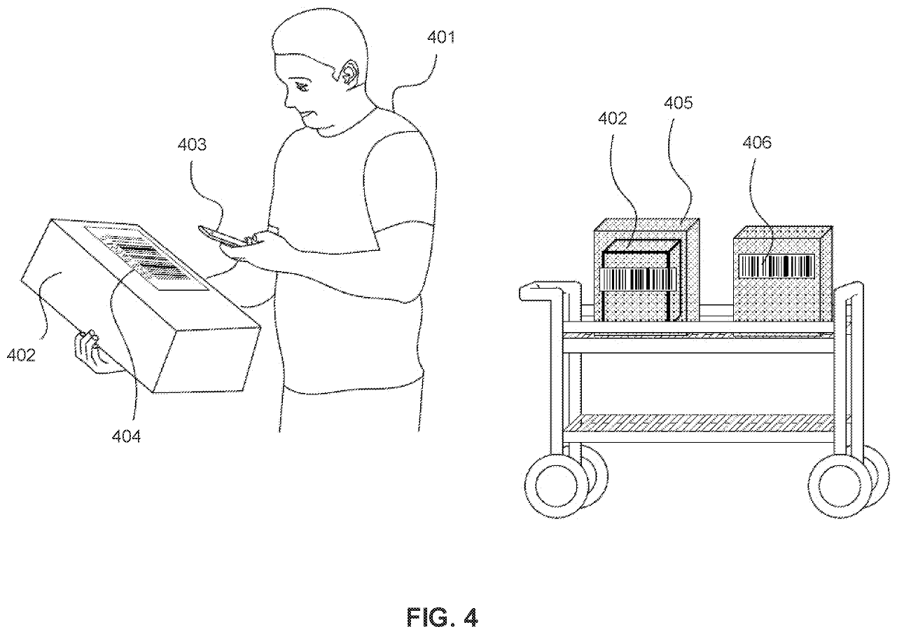

FIG. 4 illustrates an operation of a user 401, such as a stowing worker or other fulfillment center personnel, in, for example, inbound zone 203. In some embodiments, inbound products 402 may have product identifiers 404 attached to the products 402. Additionally, or alternatively, product identifiers 404 may not be attached to the products 402, but instead, may be located near the products 402. Product identifiers 404 may comprise one or more of a product barcode, a stocking keeping unit (SKU), an RFID tag, a matrix barcode, such as Quick Response (QR) code.

A camera or a scanner in a user device, such as mobile device 403, may scan product identifier 404. In some embodiments, mobile device 403 may be implemented as discussed above with respect to mobile device 119B of FIG. 1A and/or as discussed below with respect to mobile device 700. In some embodiments, a mobile device may assist a user, such as a stowing worker or other fulfillment center personnel, to find a designated location. In some embodiments, a mobile device may show a user a map with navigation. For example, the mobile device may inform a user to turn left upon reaching a certain location. In some embodiments, a mobile device may provide a signal, including, but not limited to a map, sound, vibration or text message for assisting users to find a designated location. The scanned information may be transmitted to WMS 119 via wireless or wired network.

In some embodiments, inbound products 402 may be placed in a container 405. In some embodiments, containers 405 may have container identifiers 406 attached to the containers 405. Additionally, or alternatively, container identifiers 406 may not be attached to the containers 405, but instead, may be located near the containers 405. Container identifiers 405 may comprise one or more of a product barcode, an RFID tag, a matrix barcode, such as Quick Response (QR) code, or the like. Accordingly, instead of scanning product identifiers 404, user 401 may scan container identifier 406 associated with a container 405 holding an inbound product 402 for stowing. The scanned information may be transmitted to WMS 119 via wireless or wired network.

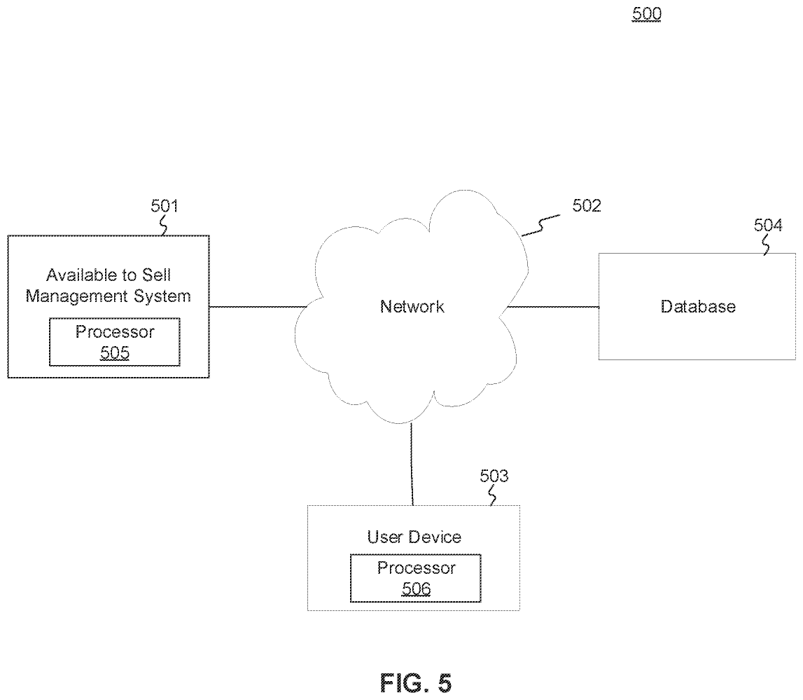

Referring to FIG. 5, a schematic block diagram illustrating an exemplary embodiment of a system 500 comprising an available to sell management system 501 for optimizing a quantity of products that are available to sell, is provided. Available to sell management system 501 may be associated with one or more systems in system 100 of FIG. 1A. For example, available to sell management system 501 may be implemented as part of the WMS 119. Additionally, or alternatively, available to sell management system 501 may be implemented as part of the FO system 113. Available to sell management system 501, in some embodiments, may be implemented as a computer system that receives scan events and generates graphical user interfaces for displaying items or products as available to sell to, for example, a customer.

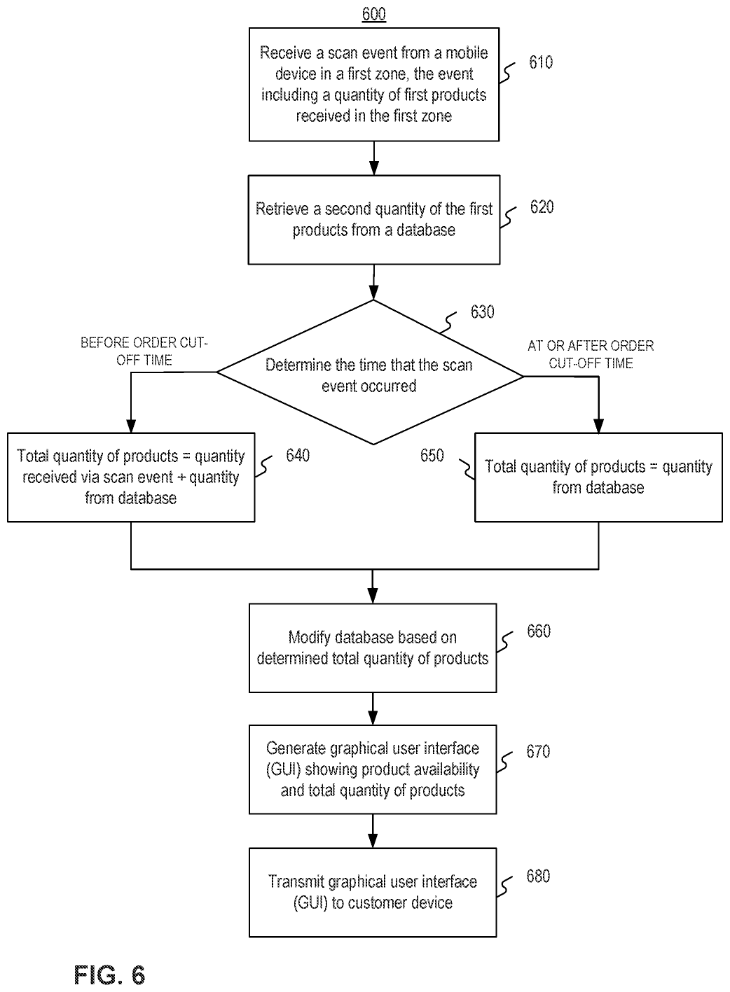

Referring to FIG. 6, available to sell management system 501 may implement a method 600 for optimizing a quantity of products that are available to sell. For example, as shown in step 610 of FIG. 6, available to sell management system 501 may include one or more processors 505, and one or more processors 505 may receive, from at least one mobile device, a scan event. In some embodiments, a scan event may include the capturing of an identifier associated with a product. Non-limiting examples of a scan event may include capturing a barcode of a product using a mobile device, manually inputting a SKU number associated with a product into a system using a mobile device, and capturing an image of a product using a mobile device. In some embodiments, as discussed further herein, a scan event received from a mobile device may include additional information, including a timestamp, identifier associated with the mobile device, a location, a username, debug information, or other data from the mobile device.

As shown in FIG. 4, a scan event may be received upon the scanning of inbound products 402 in inbound zone 203 using mobile device 403 by user, or fulfillment center personnel, 401. The scan event may include at least one identifier associated with a first quantity of products, an indication that the first quantity of products was received at a first zone, or any other information or indication associated with inbound products 402. The first quantity of products may include at least one of a product type. A product type may include—but is not limited to—a product category (e.g., Food, Silverware, Kitchen utensils, Home electronics digital, Household goods), a product brand (e.g., Local Milk, Daily dairy, Cattle and trees), or a product name (e.g., Sliced cheese, Mozzarella cheese, 100 grams of cheddar sliced cheese, Grated Parmesan Cheese, 1.36 kg of string cheese). In some embodiments, the first zone may include inbound zone 203. Furthermore, in some embodiments, the first zone may include inbound zone 203, buffer zone 205, drop zone 207, or any combination thereof. As further discussed herein, a scan event may include a second indication that the first quantity of products is located in a zone other than a second zone.

As an example, user 401 may scan product identifier 404 using mobile device 403. The product identifier 404 may be associated with a first quantity of products comprising at least one of a product type and a second quantity of products comprising the at least one of a product type. The first quantity of products may include products of different product types received at inbound zone 203. For example, the first quantity of products may include Mozzarella cheese, Rosé spaghetti sauce, Hot sauce, Bacon and Mushroom Cream Pasta Sauce, and Chili sauce. In other embodiments, the first quantity of products may include products of the same product type received at inbound zone 203. For example, the first quantity of products may include Mozzarella cheese only. Additionally, or alternatively, the first quantity of products may include the number of each product type received. For example, the first quantity of products may include one (1) Mozzarella cheese, ten (10) Rosé spaghetti sauces, twenty (20) Hot sauces, fifteen (15) Bacon and Mushroom Cream Pasta Sauces, and fifteen (15) Chili sauces.

The scan event may also include an indication that the first quantity of products was received at inbound zone 203. The indication may be determined by location information such as, but not limited to, a navigation system or other digital representation of a location of mobile device 403 at the time of scanning product identifiers 404. It is contemplated that the scan event may include an indication that the first quantity of products was received at or is located at a certain location, including any location within inbound zone 203. Furthermore, in some embodiments, the scan event may include an indication that the first quantity of products was received at a particular time. For example, the scan event may include an indication that the first quantity of products, or a portion of the first quantity of products, was received at 11:00 am. The scan event may include, for example, an ISO 8601 compliant timestamp.

System 500 may further comprise a database 504. Database 504 may be configured to store information associated with each zone in FC 200. For example, database 504 may store a list of every zone, such as picking zone or buffer zone in FC 200, physical location identifiers associated with each storage unit within each zone in FC 200, and/or quantities of products in each zone (e.g., number of products, types of products, location of products).

Database 504 may include one or more memory devices that store information and are accessed through network 302. By way of example, database 504 may include Oracle™ databases, Sybase™ databases, or other relational databases or non-relational databases, such as Hadoop sequence files, HBase, or Cassandra. While database 504 is illustrated as being included in the system 500, it may alternatively be located remotely from system 500. For example, in some embodiments, database 504 may be incorporated into one or more of external front end system 103, internal front end system 105, FO system 113, and WMS 119. In other embodiments, database 504 may be incorporated into available to sell management system 501 and/or user device 503 (e.g., one of devices 119A-119C). Database 504 may include computing components (e.g., database management system, database server, etc.) configured to receive and process requests for data stored in memory devices of database 504 and to provide data from database 504.

In some embodiments, as shown in step 620 of FIG. 6, one or more processors 505 may retrieve, from a database (e.g., database 504), a second quantity of products stored at a second zone. The second quantity of products may comprise at least one of the product type. The second quantity of products may include stowed products. In some embodiments, the second quantity of products may include stowed products located in picking zone 209. Furthermore, the second quantity of products may include the number of each product type in picking zone 209. For example, the second quantity of products may include five (5) Mozzarella cheese, two (2) Rosé spaghetti sauces, ten (10) Hot sauces, two (2) Bacon and Mushroom Cream Pasta Sauces, and eleven (11) Chili sauces. In some embodiments, the second quantity of products may include a quantity associated with one product type, for example, five (5) Mozzarella cheese. The database may include information, indications, or identifiers associated with the second quantity of products such as—but not limited to—the location of each stowed product, the time that each stowed product was stowed, and whether the stowed product has been ordered.

Disclosed embodiments may involve determining a total quantity of products based on the first quantity of products and the second quantity of products, as shown in step 630 of FIG. 6. The total quantity of products may be determined based on an order cut-off time. For example, during a first time window, such as within an order cut-off window, the determined total quantity of products may include the first quantity of products and the second quantity of products. Additionally, or alternatively, during a second time window, such as outside an order cut-off window, the determined total quantity of products may include only the second quantity of products.

In some embodiments, an order cut-off window may be determined by one or more set times, one or more lead times, or a combination of one or more set times and one or more lead times. As a non-limiting example, one or more processors 505 may determine—using one or more set times, one or more lead times, or a combination of one or more set times and one or more lead times—an order cut-off window. The one or more set times and one or more lead times may be stored in a database (e.g., database 504), where the database may be incorporated within a system such as external front end system 103, internal front end system 105, shipment and order tracking system 111, FO system 113, supply chain management system 117, and/or WMS 119. In some embodiments, the one or more set times and/or one or more lead times may be automatically set by a system based on factors such as—but not limited to—product availability, product expiration date, expected demand for a product, and a quantity of products received at an FC. In other embodiments, the one or more set times and/or one or more lead times may be manually set by, for example, fulfillment center personnel. Furthermore, in some embodiments, the order cut-off window may be manually set by fulfillment center personnel. Additionally, or alternatively, the order cut-off window may be stored in the database (e.g., database 504).

For example, a first set time may include, but is not limited to, 10:00 AM, and a second set time may include, but is not limited to 12:00 AM. A lead time may include, but is not limited to, five (5) hours. A lead time may be associated with the duration of time a product must be stowed (e.g., transferred from a zone other than picking zone 209, to picking zone 209) within, or the duration of time it takes a product to be stowed. The order cut-off window may be determined by the one or more set times and one or more lead times as follows: products received after the first set time, but before the second set time minus the lead time, may be considered to fall within the order cut-off window. Continuing the example, with a first set time as 10:00 AM, a second set time as 12:00 AM, and a lead time as five (5) hours, the order cut-off window may include 10:00 AM-7:00 PM. It is contemplated that the set times may include any time, the lead times may include any duration, and the order cut-off window may be determined in any suitable manner for deciding when a product should be listed as available to sell to a customer after arrival at an FC.

Continuing the example above, and as shown in step 640 of FIG. 6, if the first quantity of products is received within order cut-off window of 10:00 AM-7:00 PM, the total quantity of products may be determined to be the sum of the first quantity of products (e.g., via the scan event) and the second quantity of products (e.g., via the database). If the first quantity of products is received outside of the order cut-off window of 10:00 AM-7:00 PM, as shown in step 650 of FIG. 6, the total quantity of products may be determined to be the second quantity of products (e.g., via the database) only.

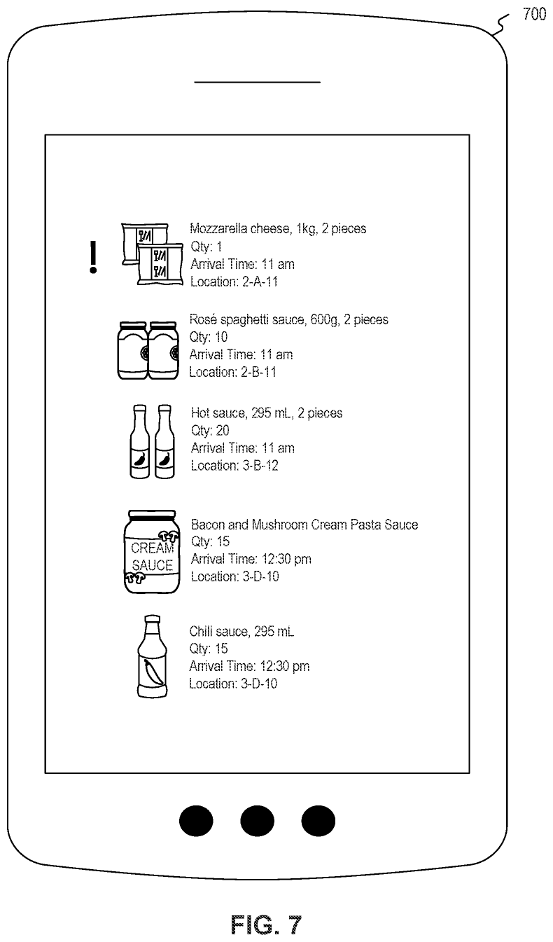

For example, if the first quantity of products is received at 11 AM and/or 12:30 PM, as shown in FIG. 7 as the Arrival Time of each product type, the total quantity of products may be determined to be the sum of the first quantity of products and the second quantity of products (e.g., as listed in the examples above): six (6) Mozzarella cheese, twelve (12) Rosé spaghetti sauces, thirty (30) Hot sauces, seventeen (17) Bacon and Mushroom Cream Pasta Sauces, and twenty-six (26) Chili sauces. As another example, if the first quantity of products is received at 9:00 PM, the total quantity of products may be determined to be the second quantity of products only (e.g., as listed in the examples above): five (5) Mozzarella cheese, two (2) Rosé spaghetti sauces, ten (10) Hot sauces, two (2) Bacon and Mushroom Cream Pasta Sauces, and eleven (11) Chili sauces.

Database 504 may be modified based on the determined total quantity of products. Furthermore, database 504 may be modified in a manner that does not break or interfere with existing infrastructure of database 504 and/or the operation of any other systems, such as external front end system 103, internal front end system 105, shipment and order tracking system 111, FO system 113, supply chain management system 117, and/or WMS 119. For example, in traditional systems, an available-to-sell table may be provided, and the available-to-sell table may include the quantity of products that have been received and stowed at the fulfillment center. Disclosed embodiments may provide a first table for the first quantity of products (e.g., received but not yet stowed) and a second table for the second quantity of products (e.g., received and stowed). In some embodiments, the first and second table may be introduced into database 504 such that the infrastructure of database 504 is not broken (e.g., by combining values in the first and second table based on the determining total quantity of products and updating the existing available-to-sell table in database 504).

System 500 may also comprise a network 502. Available to sell management system 501, customer device 503, and database 504 may be connected and be able to communicate with each other via network 502. Network 502 may be one or more of a wireless network, a wired network or any combination of wireless network and wired network. For example, network 502 may include one or more of a fiber optic network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving data.

In addition, network 502 may include, but not be limited to, telephone lines, fiber optics, IEEE Ethernet 802.3, a wide area network (“WAN”), a local area network (“LAN”), or a global network such as the Internet. Also network 502 may support an Internet network, a wireless communication network, a cellular network, or the like, or any combination thereof. Network 502 may further include one network, or any number of the exemplary types of networks mentioned above, operating as a stand-alone network or in cooperation with each other. Network 502 may use one or more protocols of one or more network elements to which they are communicatively coupled. Network 502 may translate to or from other protocols to one or more protocols of network devices. Although network 502 is depicted as a single network, it should be appreciated that according to one or more embodiments, network 502 may comprise a plurality of interconnected networks, such as, for example, the Internet, a service provider's network, a cable television network, corporate networks, and home networks.

System 500 may also comprise a server (not shown). The server may be a web server (e.g., external front end system 103). The server, for example, may include hardware (e.g., one or more computers, including processors, storage, and input/output devices) and/or software (e.g., one or more applications) that deliver web content that can be accessed by, for example a user through a network (e.g., network 502), such as the Internet. The server may use, for example, a hypertext transfer protocol (HTTP or HTTPS) to communicate with a user. The web pages delivered to the user may include, for example, HTML documents, which may include images, style sheets, and scripts in addition to text content.

A customer program such as, for example, a web browser, web crawler, or native mobile application, may initiate communication by making a request for a specific resource using HTTP and the server may respond with the content of that resource or an error message if unable to do so. The server also may enable or facilitate receiving content from the user so the user may be able to, for example, submit web forms, including uploading of files. The server may also support server-side scripting using, for example, Active Server Pages (ASP), PHP, or other scripting languages. Accordingly, the behavior of the server can be scripted in separate files, while the actual server software remains unchanged.

In other embodiments, the server may be an application server, which may include hardware and/or software that is dedicated to the efficient execution of procedures (e.g., programs, routines, scripts) for supporting its applied applications. The server may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. The server may act as a set of components accessible, for example, through an API defined by the platform itself. For Web applications, these components may be performed in, for example, the same running environment as web servers, and application servers may support the construction of dynamic pages. Application servers also may implement services, such as, for example, clustering, fail-over, and load-balancing. In various embodiments, where application servers are Java application servers, the web servers may behave like an extended virtual machine for running applications, transparently handling connections to databases associated with a backend on one side, and connections to the Web client on the other. The web server may, in some embodiments, deliver data comprising a graphical user interface.

Customer device 503 may be any computer device, or communications device including, but not limited to, a server, a network appliance, a personal computer (PC), a workstation, a mobile device, a phone, a handheld PC, a personal digital assistant (PDA), a thin client, a tablet computer, a smartphone, a fat client, an Internet browser, or other device. Customer device 503 may also be a tablet computer. For example, in some embodiments, customer device 503 may be implemented as one or more of devices 102A or 102B. Non-limiting examples of a tablet computer include an iPad, Kindle Fire, Blackberry PlayBook, HP Touchpad, and the like. Customer device 503 may be associated with a customer having one or more accounts.

A customer may navigate a graphical user interface (GUI), generated by one or more processors 505, using customer device 503 via external front end system 103. For example, in some embodiments, one or more processors 505 may generate and transmit a graphical user interface (GUI) to customer device 503, as shown by example in steps 670 and 680 of FIG. 6. The graphical user interface (GUI) may be transmitted to customer device 503 via one or more processors 505 or network 502. In some embodiments, the graphical user interface (GUI) may be received by one or more processors 506. Furthermore, in some embodiments, the graphical user interface (GUI) may include a Search Result Page (SRP) (e.g., FIG. 1B), Single Detail Page (SDP) (e.g., FIG. 1C), Cart page (e.g., FIG. 1D), Order page (e.g., FIG. 1E), or any other page including interactive user interface elements. Additionally, or alternatively, the graphical user interface (GUI) may include a product availability and the total quantity of products. For example, as shown in FIG. 1C, the graphical user interface (GUI) may include a Single Detail Page (SDP) showing Mozzarella cheese, and the product availability (such as an in-stock indication) and total quantity of products (such as Total quantity: 2) may be shown. In some embodiments, an in-stock indication may include any text or graphical representation that a product is available or in stock. Additionally, or alternatively, the Total quantity may include the product availability, as a Total quantity of 0 may indicate that the product is not available, and a Total quantity greater than 0 may indicate that the product is available.

In disclosed embodiments, one or more processors 505 may receive, via the graphical user interface (GUI), an order from customer device 503. The order may include order information including a selected quantity of the product type. Furthermore, in some embodiments, one or more processors 505 may assign a priority stow indication to a first at least one product of the first quantity of products based on the order information, and a priority stow indication may include a notification to a mobile device (e.g., mobile device 403) and/or a rearrangement of a list of products to be stowed. An assignment of a priority stow indication to a product may include any method or manner of prioritizing the stowing of the product.

For example, a customer may order one (1) Mozzarella cheese, as shown in the sample Cart page of FIG. 1D. As shown in FIG. 7, and continuing the example above, a priority stow indication (shown as an exclamation mark symbol) may be assigned to Mozzarella cheese, based on order information.

FIG. 7 depicts a sample Stow page that includes products to be stowed, and a priority stow indication. The Stow page may be displayed on at least one mobile device 700 and may include a list of products to be stowed. Each product to be stowed may include a product description, product quantity, product arrival time, and product location. It is contemplated that the Stow page may include any information associated with products to be stowed and is not limited to the examples provided.

A worker may use at least one mobile device 700 to locate products to be stowed. For example, as discussed previously, one or more processors 505 may receive, from a first at least one mobile device 403, location information associated with a location of the first quantity of products. The location information may be received at the time of the scan event. In some embodiments, one or more processors 505 may transmit the location information to a second at least one mobile device 700 for retrieving the first at least one product of the first quantity of products. The transmitting may be performed after the first at least one product is ordered by a customer.

Consistent with the previous example, a customer may order one (1) Mozzarella cheese, as shown in the sample Cart page of FIG. 1D. During the scan event, and prior to the customer order, one or more processors 505 may receive location information from the first at least one mobile device 403. The scan event may also include the location of Mozzarella cheese that is not yet stowed. Upon receiving the order, one or more processors 505 may transmit the location information of Mozzarella cheese, that is not yet stowed, to the second at least one mobile device 700, shown in FIG. 7, enabling a stowing worker or other fulfillment center personnel to retrieve the Mozzarella cheese.

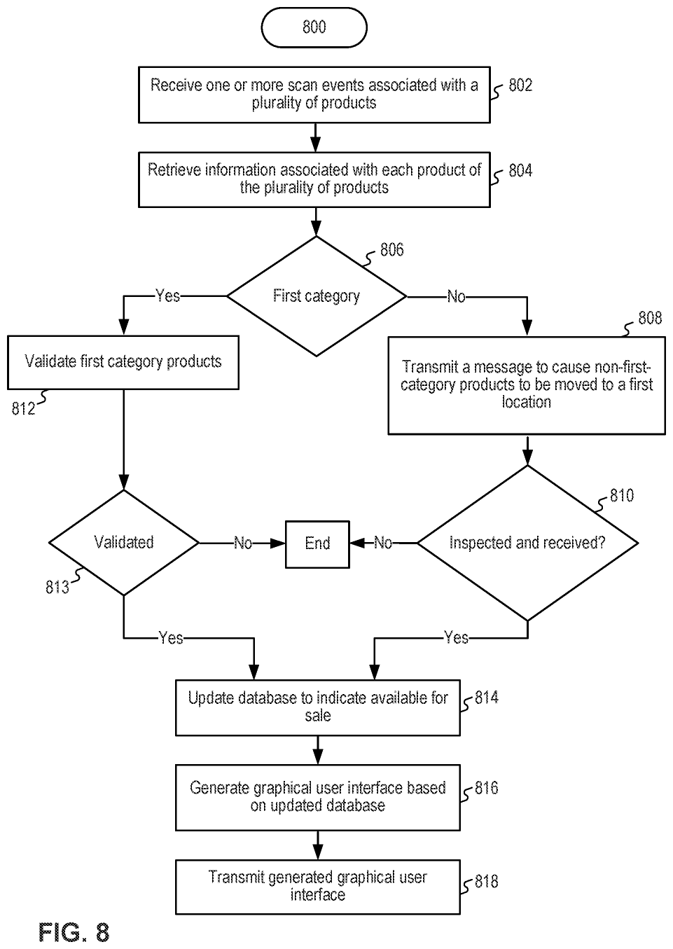

FIG. 8 shows an exemplary method 800 for optimizing availability of products, according to some disclosed embodiments. In some embodiments, method 800 or a portion thereof may be performed by one or more processors 505 of available to sell management system 501, while in other embodiments, method 800 or portions thereof may be performed by other components in FIG. 1. For example, systems may include one or more processors and a memory storing instructions that, when executed by the one or more processors, cause the system to perform the steps shown in FIG. 8.

At step 802, at least one processor may be configured to receive one or more scan events associated with a plurality of products. In some embodiments, the one or more scan events may be associated with at least one of a purchase order, stock keeping unit, global cart barcode, container tote barcode, or any other scannable identifier. For example, the at least one processor may be configured to receive at least one of a global cart barcode or container tote barcode representing a group of products. In some embodiments, the at least one processor may be configured to receive the one or more scan events from at least one mobile device. In some embodiments, a scan event may include the capturing of one or more identifiers associated with the plurality of products. Non-limiting examples of a scan event include capturing a barcode of a product using a mobile device, manually inputting a SKU number associated with a product into a system using a mobile device, or capturing an image of a product using a mobile device. In some embodiments, as discussed further herein, a scan event received from a mobile device may include additional information, including a timestamp, identifier associated with the mobile device, a location, a username, debug information, or other data from the mobile device.

As discussed above with respect to FIG. 4, one or more scan events may be received by at least one processor upon the scanning of inbound products 402 in inbound zone 203 using mobile device 403 by user, or fulfillment center personnel 401. The one or more scan events may each include at least one identifier associated with the plurality of products, an indication that the plurality of products was received at a first zone, or any other information or indication associated with inbound products 402. The plurality of products may include at least one product type. A product type may include, but is not limited to, a product category (e.g., Food, Silverware, Kitchen utensils, Home electronics digital, Household goods), a product brand (e.g., Local Milk, Daily dairy, Cattle and trees), or a product name (e.g., Sliced cheese, Mozzarella cheese, 100 grams of sliced cheddar cheese, Grated Parmesan Cheese, 1.36 kg of string cheese). In some embodiments, the first zone may comprise inbound zone 203. In some embodiments, the first zone may include inbound zone 203, buffer zone 205, drop zone 207, or any combination thereof.

As an example, user 401 may scan product identifier 404 using mobile device 403. In some embodiments, user 401 may scan a product identifier for each individual product of the plurality of products. In some embodiments, user 401 may scan one or more tote identifiers, wherein each tote identifier corresponds to a tote containing a group of products of the plurality of products. In some embodiments, the group of products may comprise at least one product type. In some embodiments, the plurality of products may include products of different product types received at inbound zone 203. For example, the plurality of products may include Mozzarella cheese, Rosé spaghetti sauce, Hot sauce, Bacon and mushroom cream pasta sauce, and Chili sauce. In other embodiments, the plurality of products may include products of the same product type received at inbound zone 203. For example, the plurality of products may only include Mozzarella cheese. Additionally or alternatively, the one or more scan events may indicate a number of each product type received associated with the plurality of products. For example, the plurality of products may include one (1) Mozzarella cheese, ten (10) Rosé spaghetti sauces, twenty (20) Hot sauces, fifteen (15) Bacon and mushroom cream pasta sauces, and fifteen (15) Chili sauces.

In some embodiments, the one or more scan events may include one or more indications that the plurality of products was received at inbound zone 203. The indication may be determined by location information such as, but not limited to, a navigation system or other digital representation of a location of mobile device 403 at the time of scanning one or more identifiers. It is contemplated that the one or more scan events may include one or more indications that the plurality of products was received at or is located at a certain location, including any location within inbound zone 203. Furthermore, in some embodiments, the one or more scan events may include one or more indications that the plurality of products was received at one or more particular times. For example, a scan event may include an indication that the plurality of products, or a portion of the plurality of products, was received at 11:00 am. Each scan event may include, for example, an ISO 8601 compliant timestamp.

In some embodiments, the one or more scan events may include a current location associated with the plurality of products, and the at least one processor may be configured to determine whether the current location corresponds to a first zone prior to determining whether one or more products of the plurality of products are associated with a first category. For example, the first zone may comprise an inbound zone of a destination fulfillment center, wherein the destination fulfillment center may comprise a fulfillment center where products are stowed prior to delivery to customers. Based on determining that the current location corresponds to the first zone, the at least one processor may proceed to step 804. Based on determining that the current location does not correspond to the first zone, the at least one processor may end method 800.

At step 804, the at least one processor may be configured to retrieve, from a database (e.g., database 504), information associated with each product of the plurality of products. In some embodiments, the database may comprise an internal database of available to sell management system 501. In some embodiments, the database may assign the plurality of products one or more categories based on one or more identifiers (e.g., product identifier, location identifier, tote identifier), and the retrieved information from the database may include the one or more categories associated with the identifier. In some embodiments, a category may comprise at least one of a direct category or a transfer category. In some embodiments, the direct category may be assigned to products received directly from sellers. In some embodiments, the transfer category may be assigned to products received from one or more transfer centers, such as cross-dock warehouses, replenishment centers, or other fulfillment centers. In some embodiments, a first subset of products of the plurality of products may be associated with a different category than a second subset of products of the plurality of products.

In some embodiments, as shown in step 620 of FIG. 6, at least one processor may retrieve, from a database (e.g., database 504), a quantity of products stored at a second zone. The quantity of products may comprise at least one of the product type. The quantity of products may include stowed products. In some embodiments, the quantity of products may include stowed products located in picking zone 209. Furthermore, the quantity of products may include a number of each product type in picking zone 209. For example, the quantity of products may include five (5) Mozzarella cheese, two (2) Rosé spaghetti sauces, ten (10) Hot sauces, two (2) Bacon and mushroom cream pasta sauces, and eleven (11) Chili sauces. In some embodiments, the quantity of products may include a quantity associated with one product type, for example, five (5) Mozzarella cheese. The database may include information, indications, or identifiers associated with the second quantity of products such as, but not limited to, a location of each stowed product, a time that each stowed product was stowed, and whether the stowed product has been ordered.

At step 806, the at least one processor may be configured to determine, based on the retrieved information, whether one or more products of the plurality of products are associated with the transfer category (in FIG. 8, a “first” category). In response to determining that a first subset of products of the plurality of products is associated with the direct (in FIG. 8, “non-first”) category (i.e., step 806 is NO), the at least one processor may proceed to step 808. At step 808, the at least one processor may be configured to transmit a first message to at least one user device to cause the first subset of products to be moved to a first location for inspection. For example, one or more users in inbound zone 203 may each receive one or more messages via mobile device 403 to move the first subset of products to an inspection zone of inbound zone 203. In some embodiments, one or more automated transport machines may be configured to receive instructions to move the first subset of products to the first location. In the inspection zone, one or more users and/or one or more automated machines (e.g., robot) may be configured to inspect the first subset of products for any damages or quality issues. Additionally or alternatively, one or more users, one or more automated machines, and/or the at least one processor may be configured to identify product information associated with each product of the first subset of products. In some embodiments, the at least one processor may be configured to check whether identified product information (e.g., expiration date) associated with each product of the first subset of products matches the retrieved information. In some embodiments, each product of the first subset of products may be given a quality score. Products given a quality score below a predetermined threshold may be discarded or set aside for further inspection. Products given a quality score above the predetermined threshold may standby for reception. At reception, one or more user devices may transmit a second message confirming that the products have been inspected and received.

At step 810, in response to receiving the second message confirming that the first subset of products has been inspected and received the at least one processor may be configured to update the database to indicate that the first subset of products is available for sale. In some embodiments, updating the database may comprise adding one or more product identifiers associated with the first subset of products to a first table of the database. For example, the first table of the database (e.g., first table discussed above with respect to database 504) may include one or more product identifiers associated with products that have been received, have not been stowed and are available for sale. In some embodiments, the database may include a second table (e.g., second table discussed above with respect to database 504) including one or more identifiers associated with products that have been stowed. Additionally or alternatively, the first table may be different from the second table.

Returning to step 806, in response to determining that a second subset of products of the plurality of products is associated with the transfer category (i.e., step 806 is YES), the at least one processor may proceed to step 812. At step 812, the at least one processor may be configured to validate the second subset of products.

In some embodiments, validating the second subset of products may include determining whether a scan time stored in a received scan event associated with the second subset of products is within a preset time range. For example, the preset time range may comprise an order cut-off window, wherein products received within the order cut-off window may be made available for sale. In some embodiments, the preset time range may be manually set by fulfillment center personnel. In some embodiments, the preset time range may be dynamically determined by one or more machine learning models trained to predict one or more lead times. For example, the one or more machine learning models may be trained based on historical information stored in a database (e.g., database 504), such as information associated with one or more past lead times for stowing and delivering products at a destination fulfillment center. In some embodiments, historical information may include past lead times and/or cycle times under specific conditions (e.g., weather, seasonality, time of day, destination, routes, etc.). Using such information, the one or more machine learning models may be able to identify patterns in lead time to provide an optimal order cut-off window.

In some embodiments, validating the second subset of products may further include determining, using the retrieved information from the database, whether a product identifier associated with the second subset of products is included in a predetermined list of identifiers. For example, the predetermined list of identifiers may include identifiers corresponding to blacklisted products, products associated with one or more special packaging processes (e.g., particular items, such as fragile food items or items that must be separately packaged), or any other products that may have a longer lead time or buffer time.

In some embodiments, an inspection step (similar to that discussed above with respect to at least step 810) may occur before or after step 813, e.g., by a user in inbound zone 203 receiving messages via mobile device 403 to move the first subset of products to an inspection zone of inbound zone 203. In other embodiments, such an inspection step may not occur, for example, because the products were already inspected at another fulfillment center.

In response to the second subset of products not passing validation, (i.e., step 813 is NO), the at least one processor may end method 800. For example, in response to determining that the scan time is not within the present time range or determining that the product identifier is included in the predetermined list of identifiers, the at least one processor may forgo updating the database to indicate that the second subset of products is available for sale.

In response to the second subset of products successfully passing validation, such as determining that the scan time is within the preset time range and determining that the product identifier is not included in the predetermined list of identifiers (i.e., step 813 is YES), the at least one processor may proceed to step 814. At step 814, the at least one processor may be configured to update the database to indicate that the second subset of products is available for sale. In some embodiments, updating the database may comprise adding one or more product identifiers associated with the second subset of products to the first table of the database.

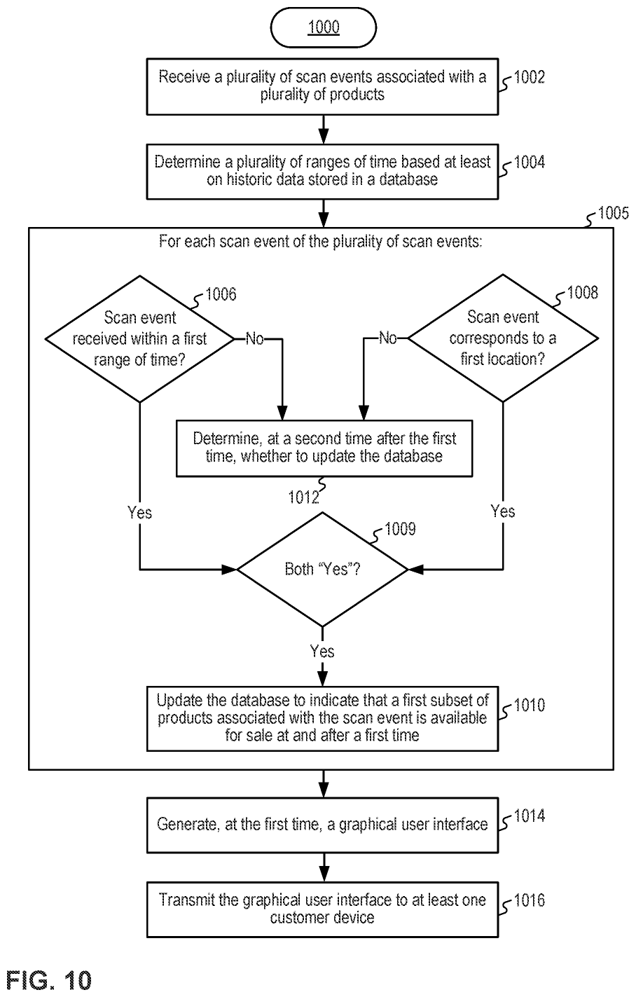

At steps 816 and 818, the at least one processor may be configured to generate a graphical user interface based on the updated database and transmit the graphical user interface to at least one customer device. For example, the at least one processor may be configured to generate and transmit a graphical user interface (GUI) to customer device 503, such as interface 1000 of FIG. 10. The graphical user interface (GUI) may be transmitted to customer device 503 via one or more processors 505 or network 502. In some embodiments, the graphical user interface (GUI) may be received by one or more processors 506. In some embodiments, the graphical user interface may comprise a webpage. Furthermore, in some embodiments, the graphical user interface (GUI) may include a Search Result Page (SRP) (e.g., FIG. 1B), Single Detail Page (SDP) (e.g., FIG. 1C), Cart page (e.g., FIG. 1D), Order page (e.g., FIG. 1E), or any other page including interactive user interface elements. Additionally, or alternatively, the graphical user interface (GUI) may include a product availability and the total quantity of products, wherein the product availability comprises a stock amount of each product. For example, as shown in FIG. 1C, the graphical user interface (GUI) may include a Single Detail Page (SDP) showing Mozzarella cheese, and the product availability (such as an in-stock indication) and total quantity of products (such as Total quantity: 2) may be shown. In some embodiments, an in-stock indication may include any text or graphical representation that a product is available or in stock. Additionally, or alternatively, the Total quantity may include the product availability, as a Total quantity of 0 may indicate that the product is not available, and a Total quantity greater than 0 may indicate that the product is available. In some embodiments, the graphical user interface may be generated by the at least one customer device. For example, the at least one processor may be configured to transmit at least a portion of the contents of the updated database to the at least one customer device, which may be configured to generate the graphical user interface based on the received portion of the contents.

In some embodiments, the at least one processor may be further configured to automatically generate and transmit a message indicating the updated database. For example, in response to receiving an indication that the database has been updated, the at least one processor may be configured to generate and transmit a message in a standardized format over a network (e.g., network 502) to all customer devices (e.g., user devices 503) accessing the webpage. Doing so may allow all customers accessing the webpage to be notified of any changes without having to manually look up or consolidate all product availability updates. In some embodiments, the message may comprise a pop-up user-interface element on the webpage, email message, text message, or any other type of message.

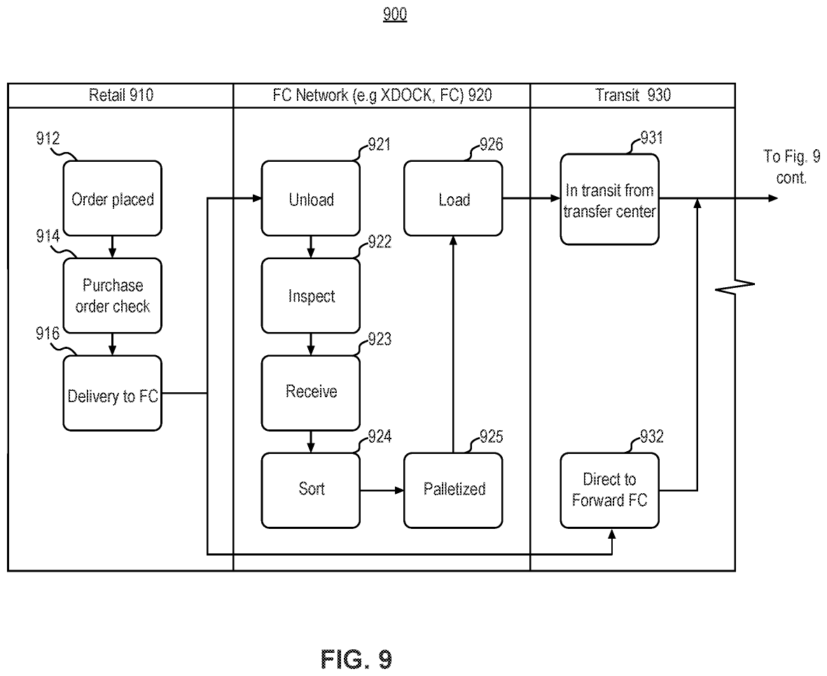

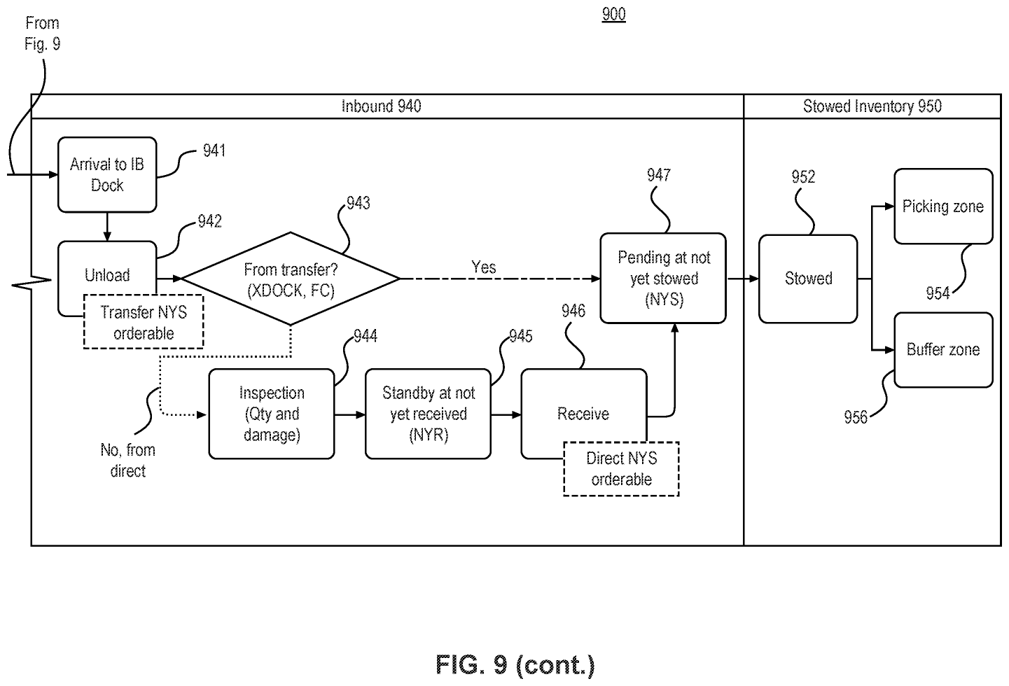

FIG. 9 illustrates an exemplary fulfillment process 900 for making products orderable, according to some disclosed embodiments. Retail phase 910 may initiate once a customer places an order for one or more products at 912. In response, a purchase order may be created and sent out to one or more vendors at 914. At 916, the one or more vendors may deliver their products. Some vendors, such as smaller vendors, may deliver products to one or more transfer centers of a fulfillment center (FC) network 920, such as a cross-dock (e.g., facility for directly transferring inbound products from vendors to outbound trucks for delivery, either to customers or to a destination fulfillment center), replenishment center (e.g., warehouse for managing inventory and replenishing retail stores or FCs in order to meet customer demand), or any FC that is not a destination FC. At the one or more transfer centers, products may be unloaded 921, inspected 922, received 923, sorted 924, palletized 925, and loaded 926 for transit 930. Transit 930 may include delivery from one or more transfer centers to one or more destination fulfillment centers at 931. Some vendors may directly send products to the one or more destination FCs at 932.

Once products arrive at the inbound zone of a destination FC (e.g., 941), they may be unloaded (e.g., 942). At that point, any products identified as coming from one or more transfer centers may be made orderable/sellable (e.g., steps 806, 812 and 814 of FIG. 8). At 943, products that are identified as direct (i.e., came directly from one or more vendors) may be inspected for any damages or quality issues (e.g., 944). At 945, products that pass inspection may standby until they are received and made orderable at 946 (e.g., steps 806, 808 and 810 of FIG. 8). After pending (e.g., 947) at not yet stowed (NYS), the direct and transferred products are stowed (e.g., 952) for picking (e.g., 954) or moved to temporary storage (e.g., 956), such as a buffer zone 205.

FIG. 10 shows an exemplary method 1000 for optimizing availability of products, according to some disclosed embodiments. In some embodiments, method 1000 or a portion thereof may be performed by one or more processors 505 of available to sell management system 501, while in other embodiments, method 1000 or portions thereof may be performed by other components in FIG. 1. For example, systems may include one or more processors and a memory storing instructions that, when executed by the one or more processors, cause the system to perform the steps shown in FIG. 10.

At step 1002, at least one processor may be configured to receive a plurality of scan events associated with a plurality of products. In some embodiments, the at least one processor may be configured to receive the plurality of scan events from at least one mobile device. In some embodiments, a scan event may include the capturing of one or more identifiers associated with the plurality of products. Non-limiting examples of a scan event include capturing a barcode of a product using a mobile device, manually inputting a SKU number associated with a product into a system using a mobile device, or capturing an image of a product using a mobile device. In some embodiments, as discussed further herein, a scan event received from a mobile device may include additional information, including at least one of a timestamp, identifier associated with the mobile device, a location (e.g., current location, destination location, starting location, etc.), a username, debug information, or other data from the mobile device.

In some embodiments, the at least one processor may be configured to receive one or more scan events upon the scanning of products in one or more transfer centers using one or more mobile devices. For example, one or more scan events may be associated with at least one of a purchase order, stock keeping unit, global cart barcode, container tote barcode, or any other scannable identifier. A transfer center may comprise a cross-dock (e.g., facility for directly transferring inbound products from vendors to outbound trucks for delivery, either to customers or to a destination fulfillment center), replenishment center (e.g., warehouse for managing inventory and replenishing retail stores or FCs in order to meet customer demand), or any FC that is not a destination FC. The one or more scan events may each include at least one identifier associated with the plurality of products, an indication that the plurality of products was received at a first location, or any other information or indication associated with received products. The plurality of products may include at least one product type. A product type may include, but is not limited to, a product category (e.g., Food, Silverware, Kitchen utensils, Home electronics digital, Household goods), a product brand (e.g., Local Milk, Daily dairy, Cattle and trees), or a product name (e.g., Sliced cheese, Mozzarella cheese, 100 grams of sliced cheddar cheese, Grated Parmesan Cheese, 1.36 kg of string cheese). In some embodiments, the first location may comprise a transfer center. In some embodiments, the first location may comprise an inbound zone, inspection zone, receiving zone, sorting zone, palletized zone, or loading zone of a transfer center.

In some embodiments, as discussed above with respect to FIG. 4, the at least one processor may be configured to receive one or more scan events upon the scanning of inbound products 402 in inbound zone 203 using mobile device 403 by user, or fulfillment center personnel, 401. The one or more scan events may each include at least one identifier associated with the plurality of products, an indication that the plurality of products was received at a first zone, or any other information or indication associated with inbound products 402. In some embodiments, the first zone may comprise inbound zone 203. In some embodiments, the first zone may include inbound zone 203, buffer zone 205, drop zone 207, or any combination thereof.

As an example, user 401 may scan product identifier 404 using mobile device 403. In some embodiments, user 401 may scan a product identifier for each individual product of the plurality of products. In some embodiments, user 401 may scan one or more tote identifiers, wherein each tote identifier corresponds to a tote containing a group of products of the plurality of products. In some embodiments, the group of products may comprise at least one product type. In some embodiments, the plurality of products may include products of different product types received at inbound zone 203. For example, the plurality of products may include Mozzarella cheese, Rosé spaghetti sauce, Hot sauce, Bacon and mushroom cream pasta sauce, and Chili sauce. In other embodiments, the plurality of products may include products of the same product type received at inbound zone 203. For example, the plurality of products may only include Mozzarella cheese. Additionally or alternatively, the one or more scan events may indicate a number of each product type received associated with the plurality of products. For example, the plurality of products may include one (1) Mozzarella cheese, ten (10) Rosé spaghetti sauces, twenty (20) Hot sauces, fifteen (15) Bacon and mushroom cream pasta sauces, and fifteen (15) Chili sauces.

In some embodiments, the one or more scan events may include one or more indications that the plurality of products was received at a first location or first zone. The indication may be determined by location information such as, but not limited to, a navigation system or other digital representation of a location of mobile device 403 at the time of scanning one or more identifiers. It is contemplated that the one or more scan events may include one or more indications that the plurality of products was received at or is located at a certain location, including any location within inbound zone 203 or the first location. Furthermore, in some embodiments, the one or more scan events may include one or more indications that the plurality of products was received at one or more particular times. For example, a scan event may include an indication that the plurality of products, or a portion of the plurality of products, was received at 11:00 am. Each scan event may include, for example, an ISO 8601 compliant timestamp.

At step 1004, the at least one processor may be configured to determine a plurality of ranges of time based at least on historic data stored in a database. In some embodiments, each range of time of the plurality of ranges of time may be associated with a destination fulfillment center. In some embodiments, each destination fulfillment center may be paired with one or more transfer centers (e.g., cross-dock), and the at least one processor may be configured to determine a range of time for each transfer center and destination fulfillment center pair. For example, a range of time associated with a pair may be determined based at least on a geographic location of each of the transfer center and the destination fulfillment center. In some embodiments, the at least one processor may be configured to determine a range of time associated with a pair based on at least one of a distance or transit time from a transfer center to a destination fulfillment center. In some embodiments, the at least one processor may be configured to retrieve historic data associated with distance or transit time from the database. In some embodiments, the at least one processor may be configured to predict a transit time from a transfer center to a destination fulfillment center based on historic data. In some embodiments, historic data may include and be organized based on at least one of an order volume, a product type, a shipping method, traffic data, transit time, lead time, buffer time, location data, or a day of the week.

In some embodiments, each range of time of the plurality of ranges of time may comprise an order cut-off window, wherein products scanned within the order cut-off window may be made available for sale after a trigger time. In some embodiments, one or more ranges of time may be manually set by fulfillment center personnel. In some embodiments, determining the plurality of ranges of time may include predicting one or more lead times associated with the plurality of products. In some embodiments, one or more machine learning models may be trained to dynamically determine one or more ranges of time. For example, the one or more machine learning models may be trained to predicting one or more lead times. For example, the one or more machine learning models may be trained based on the historic data stored in a database (e.g., database 504), such as information associated with one or more past lead times for delivering products to and stowing products at a destination fulfillment center. In some embodiments, historical information may include past lead times and/or cycle times under specific conditions (e.g., weather, seasonality, time of day, destination, routes, etc.). Using such information, the one or more machine learning models may be able to identify patterns in lead time to provide an optimal order cut-off window.

At 1005, the at least one processor may be configured to repeat steps 1006, 1008, 1009, 1010 and 1012 for each scan event of the plurality of scan events.

At 1006, the at least one processor may be configured to determine whether the scan event is received within a first range of time of the plurality of ranges of time. For example, if the scan event is received at 8:00 AM and the first range of time comprises a window of 7:00 AM-12:00 PM, the at least one processor may determine that the scan event is received within the first range of time (i.e., step 1006 is YES). Alternatively, if the scan event is received at 1:00 PM and the first range of time comprises a window of 7:00 AM-12:00 PM, the at least one processor may determine that the scan event is received after the first range of time (i.e., step 1006 is NO). In some embodiments, the at least one processor may be further configured to determine whether the scan event is received before a first time. In some embodiments, the first time may comprise a trigger time for updating product availability. For example, at the trigger time, the at least one processor may be configured to generate and transmit a graphical user interface comprising up-to-date product availability to one or more customer devices.

At 1008, the at least one processor may be configured to determine whether the current location of the scan event corresponds to a first location. In some embodiments, the first location may not be the destination fulfillment center. In some embodiments, the first location may comprise a transfer center, such as a cross-dock, replenishment center, or any FC that is not a destination FC but configured to delivery products to the destination FC. In some embodiments, the first location may comprise an inbound zone, inspection zone, receiving zone, sorting zone, palletized zone, or loading zone of a transfer center. As an example, if the current location of the scan event corresponds to an inbound zone of a destination fulfillment center and the first location comprises a sorting zone of a cross-dock, the at least one processor may determine that the current location of the scan event does not correspond to the first location (i.e., step 1008 is NO). Alternatively, if the current location of the scan event corresponds to the sorting zone of the cross-dock and the first location comprises the sorting zone of the cross-dock, the at least one processor may determine that the current location of the scan event matches the first location (i.e., step 1008 is YES).

At 1009, when the at least one processor determines that the scan event is received within the first range of time (i.e., step 1006 is YES) and the current location corresponds to the first location (i.e., step 1008 is YES), the at least one processor may proceed to step 1010. In some embodiments, the at least one processor may be configured to wait until both steps 1006 and 1008 result in “YES” before proceeding to step 1010.

At 1010, the at least one processor may be configured to update the database to indicate that a first subset of products of the plurality of products associated with the scan event is available for sale at and after the first time. In some embodiments, updating the database may comprise adding one or more product identifiers associated with the first subset of products to a first table of the database. For example, the first table of the database (e.g., first table discussed above with respect to database 504) may include one or more product identifiers associated with products that have been received, have not been stowed and are available for sale. In some embodiments, the database may include a second table (e.g., second table discussed above with respect to database 504) including one or more identifiers associated with products that have been stowed. Additionally or alternatively, the first table may be different from the second table. In some embodiments, the first table may include one or more product identifiers associated with products that have not arrived at one or more destination fulfillment centers and are available for sale at and after the first time.

In some embodiments, the at least one processor may update the first table of the database to indicate that the first subset of products of the plurality of products associated with the scan event is available for sale. If the at least one processor updates the first table before the first time, the first subset of products may not be published as available for sale to customers until the first time. At the first time, the first subset of products may be published on one or more webpages as available for sale to customers. Alternatively, if the at least one processor updates the first table after the first time, the at least one processor may immediately publish the first subset of products on one or more webpages as available for sale to customers.

In some embodiments, when the scan event is received after the first range of time (i.e., step 1006 is NO) and the current location does not correspond to the first location (i.e., step 1008 is NO), the at least one processor may proceed to step 1012. In some embodiments, when the scan event is received after the first range of time (i.e., step 1006 is NO) and the current location corresponds to the first location (i.e., step 1008 is YES), the at least one processor may proceed to step 1012. In some embodiments, when the scan event is received within the first range of time (i.e., step 1006 is YES) and the current location does not correspond to the first location (i.e., step 1008 is NO), the at least one processor may be configured to determine, at the time of the scan event, whether to update the database.

At step 1012, the at least one processor may be configured to forgo updating the database to indicate that the first subset of products of the plurality of products associated with the scan event is available for sale at the first time. In some embodiments, the at least one processor may be configured to determine, at a second time, whether to update the database to indicate that the first subset of products is available for sale. In some embodiments, the second time may be after the first time. In some embodiments, the second time may be associated with a scan event corresponding to a second location. In some embodiments, the second location may comprise a destination fulfillment center. For example, the second location may comprise an inbound zone of the destination fulfillment center. In some embodiments, the at least one processor may be configured to perform process 800 of FIG. 8 at the second time.

After steps 1006, 1008, 1009, 1010 and 1012 are repeated for each scan event of the plurality of scan events, the at least one processor may be configured to proceed to step 1014.

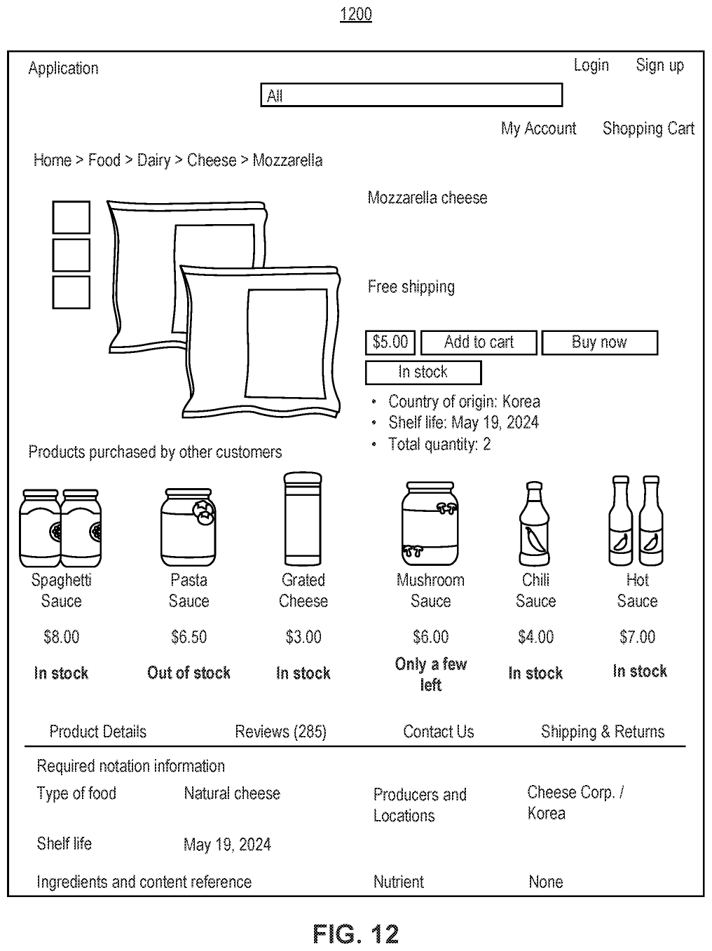

At steps 1014 and 1016, the at least one processor may be configured to generate a graphical user interface comprising an up-to-date product availability for each product of the plurality of products and transmit the generated graphical user interface to at least one customer device. For example, the at least one processor may be configured to generate and transmit a graphical user interface (GUI) to customer device 503, such as interface 1200 of FIG. 12. The graphical user interface (GUI) may be transmitted to customer device 503 via one or more processors 505 or network 502. In some embodiments, the graphical user interface (GUI) may be received by one or more processors 506. In some embodiments, the graphical user interface may comprise a webpage. Furthermore, in some embodiments, the graphical user interface (GUI) may include a Search Result Page (SRP) (e.g., FIG. 1B), Single Detail Page (SDP) (e.g., FIG. 1C), Cart page (e.g., FIG. 1D), Order page (e.g., FIG. 1E), or any other page including interactive user interface elements. Additionally, or alternatively, the graphical user interface (GUI) may include a product availability and the total quantity of products, wherein the product availability comprises a stock amount of each product. For example, as shown in FIG. 1C, the graphical user interface (GUI) may include a Single Detail Page (SDP) showing Mozzarella cheese, and the product availability (such as an in-stock indication) and total quantity of products (such as Total quantity: 2) may be shown. In some embodiments, an in-stock indication may include any text or graphical representation that a product is available or in stock. Additionally, or alternatively, the Total quantity may include the product availability, as a Total quantity of 0 may indicate that the product is not available, and a Total quantity greater than 0 may indicate that the product is available. In some embodiments, the graphical user interface may be generated by the at least one customer device. For example, the at least one processor may be configured to transmit at least a portion of the contents of the updated database to the at least one customer device, which may be configured to generate the graphical user interface based on the received portion of the contents.

In some embodiments, the at least one processor may be further configured to automatically generate and transmit a message indicating the updated database. For example, in response to receiving an indication that the database has been updated, the at least one processor may be configured to generate and transmit a message in a standardized format over a network (e.g., network 502) to all customer devices (e.g., user devices 503) accessing the webpage. Doing so may allow all customers accessing the webpage to be notified of any changes without having to manually look up or consolidate all product availability updates. In some embodiments, the message may comprise a pop-up user-interface element on the webpage, email message, text message, or any other type of message.

In some embodiments, generating the graphical user interface may comprise updating an existing graphical user interface based on up-to-date information stored in the database. In some embodiments, the at least one processor may be configured to generate the graphical user interface at the first time. In some embodiments, the at least one processor may be configured to generate the graphical user interface before the first time. In some embodiments, the at least one processor may be configured to transmit the graphical user interface at the first time. In some embodiments, the at least one processor may be configured to continuously update the graphical user interface to reflect up-to-date product availability. In some embodiments, the at least one processor may be configured to continuously update the graphical user interface until an update end time. In some embodiments, the update end time may be manually preset. In some embodiments, the update end time may be dynamically determined by one or more machine learning models.

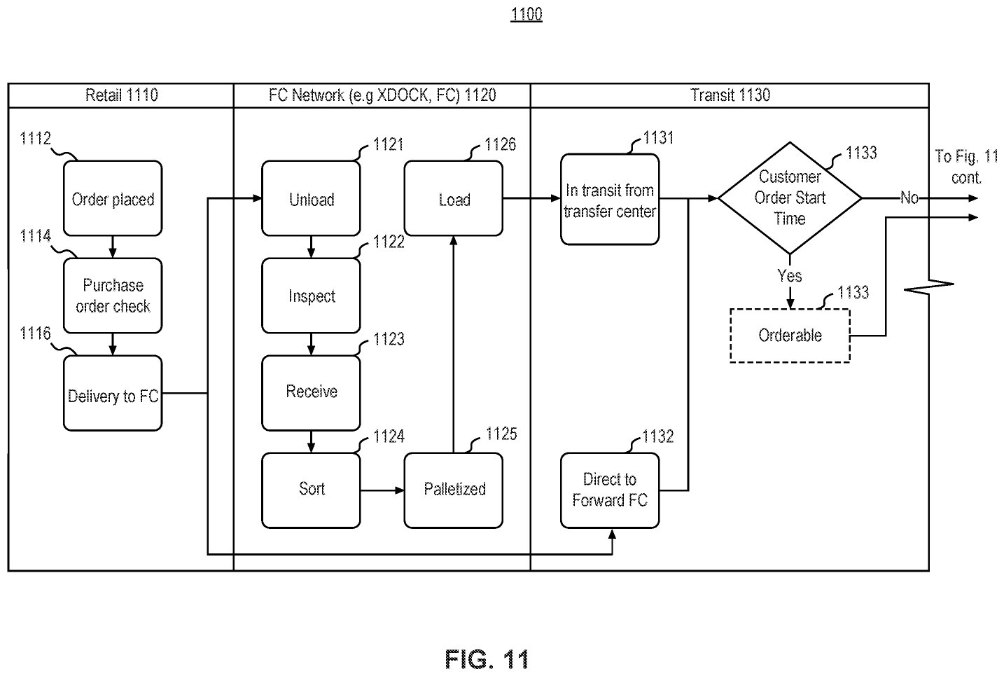

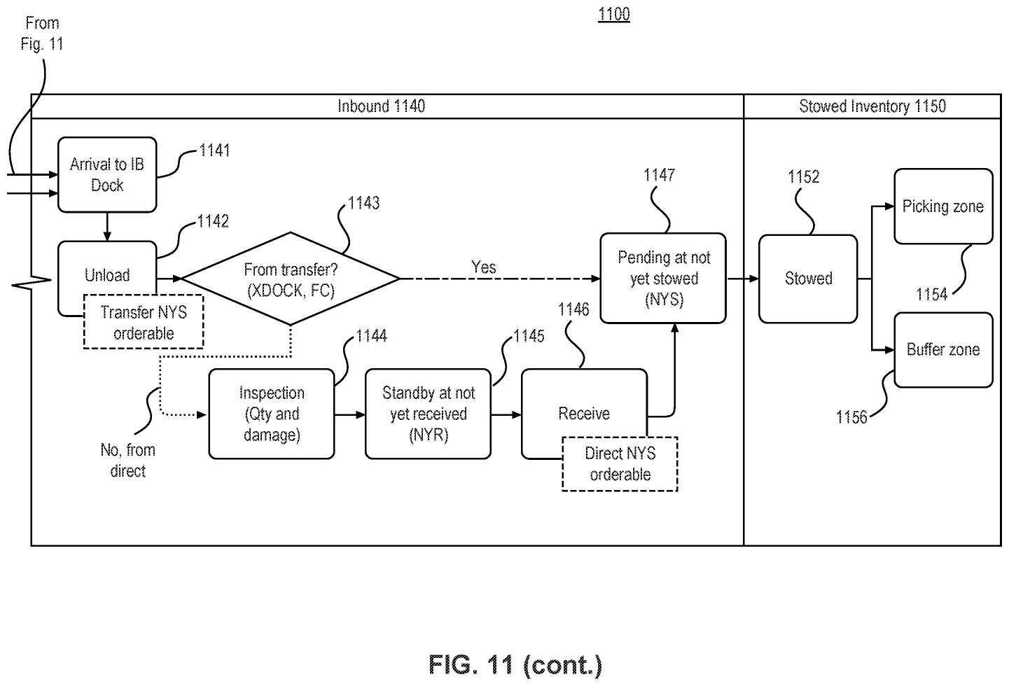

FIG. 11 illustrates an exemplary fulfillment process 1100 for making products orderable, according to some disclosed embodiments. Retail phase 1110 may initiate once an order for one or more products is sent to one or more vendors at 1112. In response, a purchase order check may be performed by receiving acceptance or denial of the purchase order or an alternative option related to the one or more products at 1114 from the one or more vendors. The purchase order check may indicate an expected quantity for reception from the one or more vendors. At 1116, the one or more vendors may deliver their products. Some vendors, such as smaller vendors, may deliver products to one or more transfer centers of a fulfillment center (FC) network 1120, such as a cross-dock (e.g., facility for directly transferring inbound products from vendors to outbound trucks for delivery, either to customers or to a destination fulfillment center), replenishment center (e.g., warehouse for managing inventory and replenishing retail stores or FCs in order to meet customer demand), or any FC that is not a destination FC. At the one or more transfer centers, products may be unloaded 1121, inspected 1122, received 1123, sorted 1124, palletized 1125, and loaded 1126 for transit 1130. Transit phase 1130 may include delivery from one or more transfer centers to one or more destination fulfillment centers at 1131. Some vendors may directly send products to the one or more destination FCs at 1132. In some embodiments, a customer order start time (e.g., first time, trigger time as discussed with respect to FIG. 10) may be implemented during transit phase 1130. For example, the customer order start time may be implemented at 1133. At 1134, any products included in an available for sale table (e.g., first table of the database discussed with respect to FIG. 10) may be published as orderable/sellable to customers on one or more webpages. In some embodiments, the one or more webpages may be continuously updated in response to new products being added to the available for sale table until a predetermined update end time.

Once products arrive at the inbound zone of a destination FC (e.g., 1141), they may be unloaded (e.g., 1142). At that point, any products identified as coming from one or more transfer centers that have not already been made orderable/sellable may be published as orderable/sellable (e.g., steps 806, 812 and 814 of FIG. 8). At 1143, products that are identified as direct (i.e., came directly from one or more vendors) may be inspected for any damages or quality issues (e.g., 944). At 1145, products that pass inspection may standby until they are received and made orderable at 1146 (e.g., steps 806, 808 and 810 of FIG. 8). After pending (e.g., 1147) at not yet stowed (NYS), the direct and transferred products are stowed (e.g., 1152) for picking (e.g., 1154) or moved to temporary storage (e.g., 1156), such as a buffer zone 205.

FIG. 12 illustrates an exemplary graphical user interface 1200 generated by method 600, 800 or 1000, according to some embodiments. Interface 1200 may be similar to the SDP of FIG. 1C. Interface 1200 may include a current product availability determined by method 600 or 800. For example, prior to performing method 600, 800 or 1000, an SDP interface may display to the customer that “MUSHROOM SAUCE” is associated with an availability of “OUT OF STOCK” (not pictured). As a result of updating the database (e.g., after performing method 600, 800 or 1000), at least one processor may be configured to generate interface 1000 which may update an availability of “MUSHROOM SAUCE” to “ONLY A FEW LEFT” as shown in FIG. 12, or “IN STOCK” (not pictured). In some embodiments, the current product availability may comprise a quantity of products available.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for optimizing availability of products for display on a graphical user interface, the system comprising:
a memory storing instructions; and
at least one processor configured to execute the instructions to perform steps comprising:
receiving a plurality of scan events associated with a plurality of products, wherein each scan event of the plurality of scan events comprises a timestamp and a current location;
determining a plurality of ranges of time based at least on historic data stored in a database, wherein each range of time of the plurality of ranges of time is associated with a destination fulfillment center;
for each scan event of the plurality of scan events:
determining whether the scan event is received within a first range of time of the plurality of ranges of time;
determining whether the current location of the scan event corresponds to a first location, wherein the first location is not the destination fulfillment center;
when the scan event is received within the first range of time and the current location corresponds to the first location,
updating the database to indicate that a first subset of products of the plurality of products associated with the scan event is available for sale at a first time; and
when the scan event is received after the first range of time and the current location does not correspond to the first location, determining, at a second time after the first time, whether to update the database to indicate that the first subset of products is available for sale;
generating, at the first time, a graphical user interface, the graphical user interface comprising a product availability for each product of the plurality of products; and
transmitting the graphical user interface to at least one customer device.

2. The computer-implemented system of claim 1, wherein determining the plurality of ranges of time includes predicting one or more lead times associated with the plurality of products.

3. The computer-implemented system of claim 2, wherein determining the plurality of ranges of time comprises using one or more trained machine learning models to determine the one or more lead times based on the historic data stored in the database.

4. The computer-implemented system of claim 1, wherein the historic data includes and is organized based on at least one of an order volume, a product type, a shipping method, traffic data, transit time, lead time, buffer time, location data, or a day of the week.

5. The computer-implemented system of claim 1, wherein the first location comprises a transfer facility.

6. The computer-implemented system of claim 1, wherein the second time is associated with a second scan event corresponding to a second location.

7. The computer-implemented system of claim 6, wherein the second location comprises an inbound zone of a destination fulfillment center.

8. The computer-implemented system of claim 1, wherein updating the database comprises adding the product identifier to a first table of the database, and wherein the first table of the database includes one or more product identifiers associated with products that have not been stowed and are available for sale.

9. The computer-implemented system of claim 8, wherein the database includes a second table including one or more identifiers associated with products that have been stowed, and wherein the first table is different from the second table.

10. The computer-implemented system of claim 1, wherein the product availability comprises a stock amount of each product of the plurality of products, and wherein the graphical user interface comprises a webpage.

11. A computer-implemented method for optimizing availability of products for display on a graphical user interface, the method comprising:
receiving a plurality of scan events associated with a plurality of products, wherein each scan event of the plurality of scan events comprises a timestamp and a current location;
determining a plurality of ranges of time based at least on historic data stored in a database, wherein each range of time of the plurality of ranges of time is associated with a destination fulfillment center;
for each scan event of the plurality of scan events:
determining whether the scan event is received within a first range of time of the plurality of ranges of time;
determining whether the current location of the scan event corresponds to a first location, wherein the first location is not the destination fulfillment center;
when the scan event is received within the first range of time and the current location corresponds to the first location,
updating the database to indicate that a first subset of products of the plurality of products associated with the scan event is available for sale at a first time; and
when the scan event is received after the first range of time and the current location does not correspond to the first location, determining, at a second time after the first time, whether to update the database to indicate that the first subset of products is available for sale;
generating, at the first time, a graphical user interface, the graphical user interface comprising a product availability for each product of the plurality of products; and
transmitting the graphical user interface to at least one customer device.

12. The computer-implemented method of claim 11, wherein determining the plurality of ranges of time includes predicting one or more lead times associated with the plurality of products.

13. The computer-implemented method of claim 12, wherein determining the plurality of ranges of time comprises using one or more trained machine learning models to determine the one or more lead times based on the historic data stored in the database.

14. The computer-implemented method of claim 11, wherein the historic data includes and is organized based on at least one of an order volume, a product type, a shipping method, traffic data, transit time, lead time, buffer time, location data, or a day of the week.

15. The computer-implemented method of claim 11, wherein the first location comprises a transfer facility.

16. The computer-implemented method of claim 11, wherein the second time is associated with a second scan event corresponding to a second location, and wherein the second location comprises an inbound zone of a destination fulfillment center.

17. The computer-implemented method of claim 11, wherein updating the database comprises adding the product identifier to a first table of the database, and wherein the first table of the database includes one or more product identifiers associated with products that have not been stowed and are available for sale.

18. The computer-implemented method of claim 17, wherein the database includes a second table including one or more identifiers associated with products that have been stowed, and wherein the first table is different from the second table.

19. The computer-implemented method of claim 1, wherein the product availability comprises a stock amount of each product of the plurality of products, and wherein the graphical user interface comprises a webpage.

20. A computer-implemented system for optimizing availability of products for display on a graphical user interface, the system comprising:
a memory storing instructions; and
at least one processor configured to execute the instructions to perform steps comprising:
receiving a plurality of scan events associated with a plurality of products, wherein each scan event of the plurality of scan events comprises a timestamp and a current location;
determining a plurality of ranges of time based at least on historic data stored in a database, wherein determining the plurality of ranges of time includes predicting one or more lead times associated with the plurality of products;
for each scan event of the plurality of scan events:
determining whether the scan event is received within a first range of time of the plurality of ranges of time;
determining whether the current location of the scan event corresponds to a first location;
based on determining that the scan event is received within the first range of time and the current location corresponds to the first location, updating the database to indicate that a first subset of products of the plurality of products associated with the scan event is available for sale at a first time; and
based on determining that the scan event is received after the first range of time and the current location does not correspond to the first location, determining, at a second time after the first time, whether to update the database to indicate that the first subset of products is available for sale;
generating a graphical user interface, the graphical user interface comprising a product availability for each product of the plurality of products; and
transmitting the graphical user interface to at least one customer device.
